(19) United States
(12) Patent Application Publication
(10) Pub. No.: US 2010/0018977 A1
(43) Pub. Date: Jan. 28, 2010

(54) Packaging Container And Method For Manufacturing Same

(75) Inventor: Achim Helmenstein, Engelskirchen (DE)

Correspondence Address: MILES & STOCKBRIDGE PC, 1751 PINNACLE DRIVE, SUITE 500, MCLEAN, VA, 22102-3833, US

(73) Assignee: Fischbach KG Kunststoff-Technik, Engelskirchen (DE)

(21) Appl. No.: 12/442,138

(22) PCT Filed: Sep. 10, 2007
(86) PCT No.: PCT/EP2007/059478

§ 371 Date: Sep. 18, 2009

(30) Foreign Application Priority Data
Sep. 22, 2006 (DE) 10 2006 044 693.3
Nov. 23, 2006 (DE) 10 2006 055 236.9

(51) Int. Cl. B65D 17/40; B29C 45/14; B32B 7/04

(52) U.S. Cl. 220/276; 264/271.1; 264/255; 156/303.1; 156/91

(57) ABSTRACT

A packaging container made of plastic has a fixed wall part (W1), produced by injection molding, and a detachable wall part (W2), which are connected by a predetermined breaking zone (20). The predetermined breaking zone (20) is covered by a barrier layer (24) which provides enhanced barrier action against gases, water vapor or solvent. The barrier layer (24) reduces the permeability of the predetermined breaking zone (20).

The invention relates to a packaging container made of plastic and provided with a predetermined breaking zone, as well as a method for producing such a packaging container.

Packaging containers are often required to have an advanced barrier effect against water vapor, gases or solvent so as to prevent leakage of these substances through the container wall. For instance, in a packaging container containing a solvent, it must be safeguarded that the solvent will not escape through the wall. In a packaging container containing a hardenable plastic composition, on the other hand, intrusion of gases or vapors with hardening or reactive effect must be safely precluded. Packaging containers for perishable products, e.g. food, must have a sufficient barrier effect against ambient influences. Other packaging containers must have a barrier against migrating substances such as e.g. oils and colorants, which might leak to the outside from the package or through the package wall.

Packaging containers should be designed to the effect that the user can open them conveniently, particularly, if possible, without the use of special tools or even of any tools at all. Packaging containers of this type are provided with a predetermined breaking zone where the container can be opened by tearing, cutting or breaking, or by striking off a part of the container.

FR 2844781 describes a cartridge provided to contain hardenable plastic compositions, wherein the neck comprises a nipple which is connected to the rest of the neck wall by a region of reduced thickness. To open the cartridge, a separate nozzle will be set onto the nipple, and the latter will be broken off from the neck. Then, the nozzle will be screwed onto a tread portion of the neck. A problem resides in that said neck region where the plastic material is of reduced thickness has a weakened barrier effect. As a consequence, vapor and gases may diffuse into the interior of the container, thus causing the plastic composition in the neck to harden and to clog the neck. A cartridge of this type wherein the neck has become clogged will be unfit for use.

DE 198 18 455 A1 describes a cartridge of plastic, in the form of a cylindrical base body provided with a tear-out cover on one of its ends. The cover is surrounded by a predetermined weakening zone and is connected to a handle. Also here, the predetermined weakening zone forms a region of reduced thickness with a lesser barrier effect.

U.S. Pat. No. 5,054,642 describes a cylindrical container with a cover mounted thereon. The cover has a metallic beaded edge, and the wall of the cover is connected to said edge by being molded therearound. The cover wall, made of plastic, includes a predetermined weakening zone with an aluminum foil applied thereon. To open the container, that part of the cover wall which is surrounded by the predetermined weakening zone can be torn out with the aid of a handling flap.

Described in EP 1 055 607 A2 is a container provided with a separate cover for subsequent mounting to the container. Said cover consists of a cover wall made of plastic and having its underside coated with a film for use as a barrier layer. In the cover wall, predetermined weakening zones are formed.

It is an object of the invention to provide a packaging container produced in one piece from plastic, which packaging container shall have a high barrier effect and protect the packaged matter from external influences while nonetheless being openable in a simple manner.

The packaging container of the invention is defined in claim 1. The container comprises a predetermined weakening zone which is bridged by a barrier layer, said barrier layer being connected to the fixed wall portion and to the severable wall portion and being effective to reduce permeation.

The predetermined weakening zone is distinguished by the reduced strength and respectively resistance of the packaging wall in said zone. This can be achieved by reduction of the wall thickness, interruption of the wall by perforations, windows or grooves, or by use of a material of low strength for the predetermined weakening zone, or by a combination of these variants.

If the barrier layer is arranged on the inner side of the wall portion of the container, it is largely protected from external influences. The barrier layer reduces the permeation of water vapor, gases, solvents and the like via the predetermined weakening zone into the packaged matter or from out of the packaged matter. Preferably, the barrier effect of the barrier layer is superior to that of the surrounding plastic. The barrier layer can include a metallic layer. For instance, the barrier layer consists of a plastic-coated aluminum foil or of a plastic film coated with aluminum by vapor deposition. Other barrier layers can consist of further plastic materials such as e.g. EVOH, being a barrier material used on the food sector, or of HDPE (high-density polyethylene). Further possible are barrier layers made of PP, PA, PET or also PVC, or they are configured as multi-layered barrier layers made from combinations of the individual materials. Under the aspect of its material as such, the barrier layer has a higher specific barrier effect than the plastic surrounding the predetermined weakening zone. The barrier effect is preferably by the factor 5 higher than that of the surrounding plastic which the wall portion of the packaging container is made of, with identical wall thickness.

The permeation of plastic and packaging materials is a material-specific value. A difference is made, for instance, between permeability to water vapor, which is relevant for water-vapor-reactive products such as silicon materials and MS polymer products, and gas permeability, which is relevant for gas-reactive products or for products to be protected from loss of solvent.

For the barrier layer, various one- or multi-layered film systems are suited. An optimum barrier effect is offered by metal foils such as e.g. aluminum. Another composition with high barrier effect includes the following layers: PP, PA, EVOH, PA, PE and an embedding compound.

As an alternative to the above, the barrier layer can be generated by multi-component injection molding, wherein the individual plastic melts can be injected simultaneously or successively.

When using a prefabricated barrier layer, this layer can be connected to the packaging container during the injection process in accordance with the known insert technology, namely by insertion of the barrier layer or of a carrier carrying the barrier layer into the injection-molding tool prior to the start of injection. In multi-component injection molding, different plastic melts will be injected simultaneously or successively. Another possibility of installing the barrier layer resides in applying the same in a subsequent process, e.g. by welding the barrier layer into place by heating-element welding, vibration welding, ultrasonic welding, friction welding or also by bonding.

The one-pieced nature of the container body is to be understood in the sense that the side wall and the end wall are formed as one integral part. This does not exclude the option that one or all walls may comprise a plurality of layers.

Apart from the reduction of the permeation, a further effect of the barrier layer can consist in the prevention of a migration of foreign substances from the interior of the container into the predetermined weakening zone or through the latter. Thus, it is avoided that substances from the interior of the container might damage the predetermined weakening zone or might leak to the outside through the predetermined weakening zone. This is required particularly in cases where the predetermined weakening zone is formed by a perforation or even by voids and thus comprises openings.

A preferred embodiment of the packaging container consists of a one-pieced cartridge for substances adapted to be pressed out, wherein the packaging container comprises a neck forming said fixed wall portion, which neck is closed by a cap forming the severable wall portion. Cartridges of this type normally have a sufficiently large wall thickness to protect the packaged matter from intrusion of damaging substances. In the region of the predetermined weakening zone, the wall thickness is smaller. In this region, a barrier layer with increased barrier effect is provided, preferably in form of a hood. If said hood has a closed end wall, the process of positioning the hood in the injection mold or in a welding machine is facilitated. Generally, however, the hood may merely consist of a tubular portion which is opened on both ends.

Independent claim 31 relates to a cartridge variant comprising a neck extending from the end wall, with the predetermined weakening zone being arranged in a region along the neck. In this variant, the side wall and the end wall need not be produced as one integral piece but can be produced separately from each other and then be connected at a later time.

According to another variant of the packaging container, it is provided that the packaging container comprises a cover and that said fixed wall portion is formed by an end wall of the packaging container, with the predetermined weakening zone surrounding said cover. In a container of this type, the barrier layer consists of a plane disk which is either full-surfaced or annular.

The invention is suited for any kind of packaging container, particularly if a plastic container is produced by injection-molding substantially in one piece. In the predetermined weakening zone, the wall can either be tapered or open. For instance, it is possible to form the predetermined weakening zone by open windows delimited by webs.

According to a preferred embodiment of the invention, it is provided that, in said cartridge variant, the severable wall portion is provided with outer or inner holding webs for use in the injection process. For reasons inherent to injection molding, these injection-assistance webs are required when, on the cap-side end, the plastic is being injected into the injection mold for producing the cartridge integrally with the severable wall portion. In this situation, the mold core has to be supported and centered without obstructing the passage of the liquid plastic. Normally, for this purpose, grooves are provided in the mold core. When, according to the invention, the mold core is to be covered by a hood made of the barrier-layer material, such grooves will be closed by the hood. Said outer injection-assistance webs will be generated by the provision of corresponding grooves on the hollow mold used for molding the neck and the cap. The thus generated injection-assistance webs can often be also utilized as gripping elements for twisting off the cap. When forming a cartridge in one piece, it may be necessary to provide such injection-assistance webs also in the region of the predetermined weakening zone. As a result, the mold for the container can be filled via the injection point which in the regular case is arranged on the severable wall portion. Further, the predetermined weakening zone will be less susceptible to damage due to external influences because, at a later time, such injection-assistance webs will also offer support or reinforcement to the predetermined weakening zone.

Generally, it is of advantage that the packaging container is provided with a handle for destroying the predetermined weakening zone and for removing a cover or cap. For this reason, it may be advisable that this handle is not allowed to project substantially beyond the outer geometry of the packaging container in order to prevent deformation or damage of the predetermined weakening zone as may be caused by automated packaging machines, printing machines or the like. Further, a handle not projecting beyond the outer contour of the packaging container will save packing space during storage and transportation.

The invention further relates to a method for producing a packaging container. Several variants of such a method are possible. According to a first variant, it is provided that a prefabricated barrier layer will be inserted into the injection mold. According to the further variant, a barrier-layer material will be injected against an inner side of the container wall. Further, a prefabricated barrier layer can be mounted to a likewise prefabricated container, e.g. by bonding or welding. In cases where the prefabricated container has been formed without a severable wall portion, the severable wall portion can be mounted to the container together with or subsequent to the prefabricated barrier layer. Also combinations of these variants are possible. The variants involving the prefabricated barrier layer are particularly suited for cases where the barrier layer includes a metal foil. In such cases, the barrier layer preferably consists of multi-layered composite foil, with a plastic film being provided to safeguard an intimate connection to the plastic of the wall portion that has been adhered by injection molding or welding. According to a preferred variant, the barrier layer will be applied as late as possible toward the end of the production cycle for producing the package. With particular preference, this step will be performed only subsequent to the injection-molding process or even no sooner than subsequent to the process for decorating the package. Advantageously, in this manner, negative influences that the production steps may happen to exert on the function and shape of the predetermined weakening zone of the packing, can be concealed or be corrected for with the aid of a barrier layer applied at such a subsequent time.

Preferred embodiments of the invention will be explained in greater detail hereunder with reference to the drawings.

In the drawings, the following is shown:

FIG. 1 is a view of a packaging container in the form of a cartridge for containing substances to be pressed out,

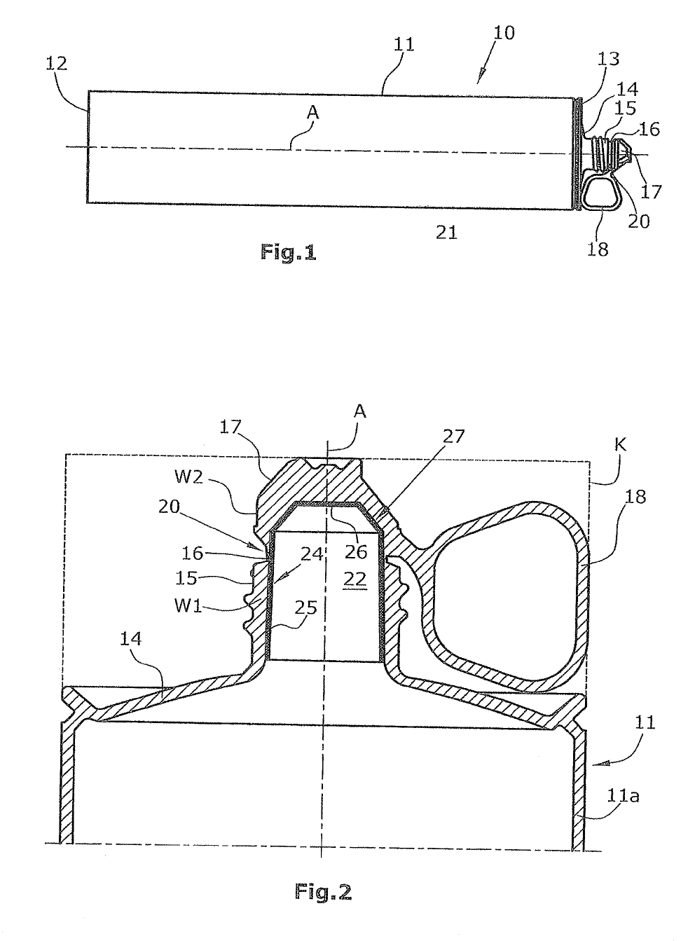

FIG. 2 is a longitudinal sectional view of the neck and the cap of the packaging container according to FIG. 1,

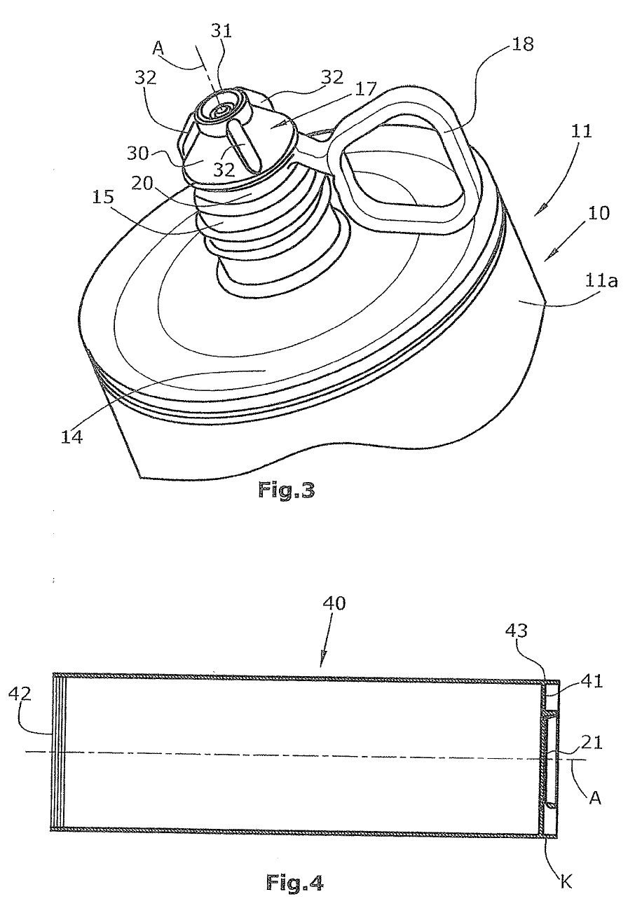

FIG. 3 is a perspective view of a part of the packaging container,

FIG. 4 is a view of a second embodiment of the packaging container,

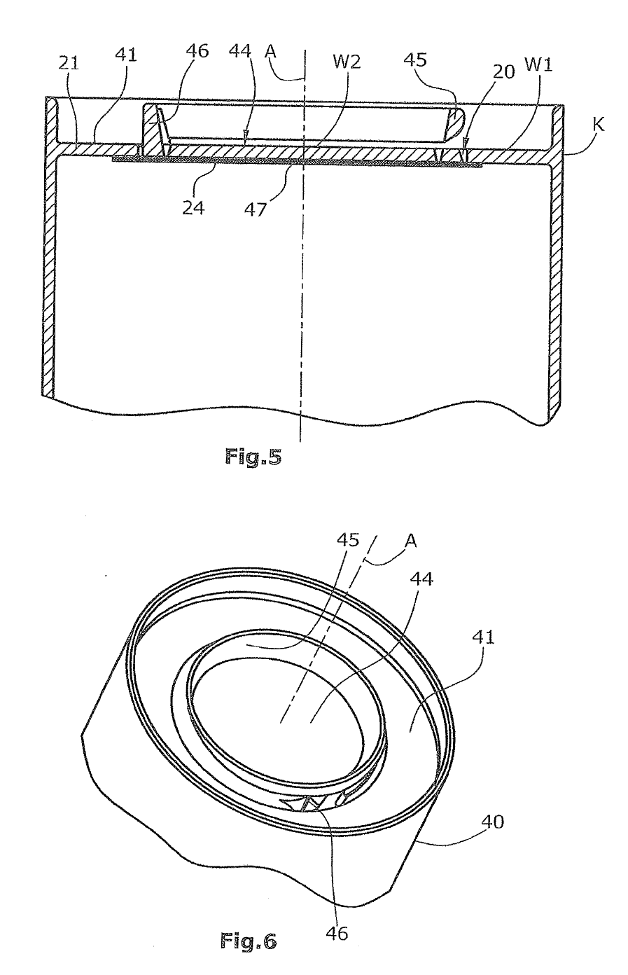

FIG. 5 is an enlarged representation of the cover-side end of the packaging container according to FIG. 4,

FIG. 6 is a perspective view of the top end of the second embodiment,

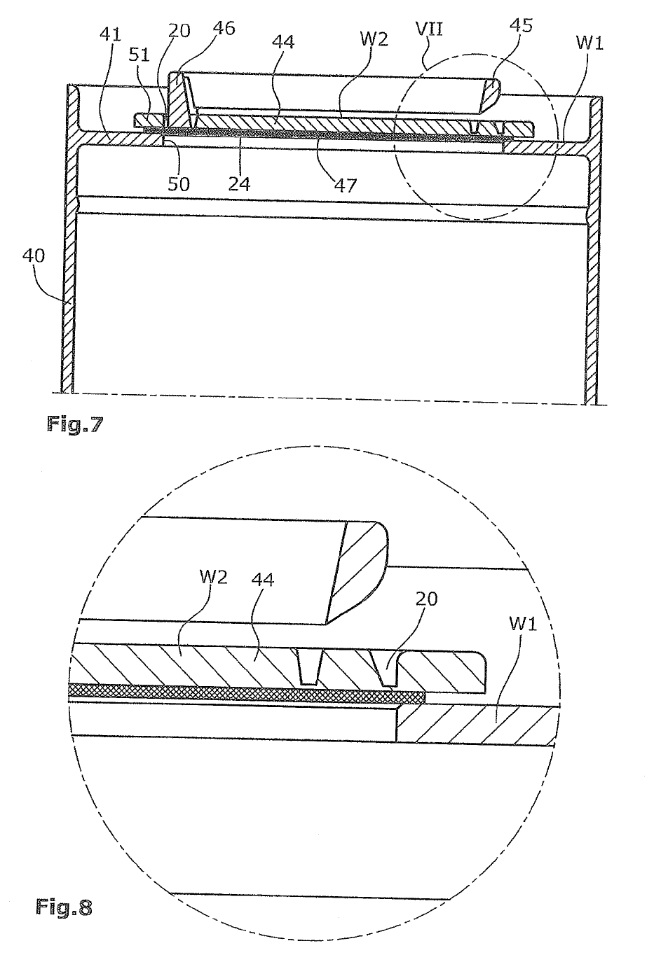

FIG. 7 is a view of a third embodiment of the packaging container, and

FIG. 8 is an enlarged representation of the detail VII in FIG. 7.

The packaging container illustrated in FIGS. 1-3 consists of a cartridge 10 for containing substances adapted to be pressed out, said cartridge comprising a cylindrical elongated container body 11 having a side wall 11a, and the rear end 12 of container body 11 is open and its front end 13 which is provided with an end wall 14. The longitudinal axis of the container body is designated by A. A tubular neck 15 with an outer thread formed thereon extends from end wall 14. Said neck 15 forms a fixed wall portion W1. Neck 15 in turn is followed by a portion 16 of reduced wall thickness, serving as a predetermined weakening zone 20. Portion 16 is followed by a cap 17 for closing the end of cap 15. Cap 17 forms a severable wall portion W2. The latter is integrally connected to a handle 18 which here is formed as a tear-off ring. Said handle is here arranged in the vertical longitudinal axis (in the direction of axis A) of the packaging container.

The whole cartridge 10 is provided as a product manufactured by injection molding in one piece from a plastic material.

Container body 11 will be filled with a hardenable plastic substance, e.g. a sealing agent or an adhesive. Thereafter, the cartridge will be closed at its rear end by introducing a piston. Said piston also serves for pressing out the substance from neck 15 after removal of cap 17.

The predetermined weakening zone 20 is located between the fixed wall portion W1 and the severable wall portion W2 (FIG. 2). The predetermined weakening zone 20 has a reduced wall thickness relative to fixed wall portion W1. This zone is the connecting region between wall portion W1 and cap 17 forming the end of the container.

In the interior space 22 of neck 15, which space is surrounded by fixed wall portion W1, the barrier layer 24 is arranged. Barrier layer 24 is arranged in close contact with the inner side of fixed wall portion W1. Said layer consists of a tubular portion 25 having an open bottom, and of an end-side portion 26 closing the upper end. Thus, the barrier layer 24 forms a hood 27 adapted to be mounted to a tool core (not shown) of an injection mold. When injection-molding the plastic around the hood 27, the contours of neck 15 and cap 17 will be generated, with hood 27 forming the inner contour. Hood 27 extends all the way down to the lower region of neck 15. As an alternative to the injection-molding of the plastic material around hood 27 in the injection mold, hood 27 can also be shifted onto a welding mandrel and then be welded into place within neck 15 and cap 17.

In the present embodiment, barrier layer 24 consists of a composite film structure comprising aluminum and provided with an external plastic layer which will enter a melting connection with the plastic of the fixed wall portion W1 and of the severable wall portion W2.

To open the packaging container, the user will pull the handle 18, thus tearing open the predetermined weakening zone 20. In the process, also barrier layer 24 will be torn. Cap 17 remains on handle 18 and will be disposed of together therewith. It will then be possible to screw a nozzle onto the thread of neck 15.

Handle 18 is located completely within the lateral contour K of container body 11.

The predetermined weakening zone 20 does not necessarily have to be produced from the plastic that the fixed wall portion W1 is made of. Zone 20 can also comprises open windows formed exclusively by the barrier layer 24. In this case, it is of advantage if webs extend from cap 17 to wall portion W1 so that the mold will be filled completely and the predetermined weakening zone will be stabilized.

As shown in FIG. 3, cap 17 comprises a frustoconical wall 30 provided with a raised ring 31 centrically extending therefrom. From said ring, radial injection-assistance webs 32 extend outwards over said frustoconical wall 30 in a star-shaped configuration. The injection-assistance webs 32 have been generated by grooves in the corresponding molding tool. Via these grooves, the liquid plastic which on the end side has been pressed into cap 17, will flow to the predetermined weakening zone 20 and farther to wall portion W1 and will finally form the overall cartridge 10. Because of the hood 27, an arrangement of corresponding injection-assistance webs in the interior of cap 17 was omitted.

The packaging container shown in FIGS. 4-6 serves for containing grease or other viscous or fluid substances. This container comprises an elongated one-pieced cylinder 40 with an open rear end 42. On its front end 43, the cylinder is closed by an end wall 41 molded to the side wall, said end wall 41 in the present embodiment forming the fixed wall portion W1 including the predetermined weakening zone 20. The predetermined weakening zone 20 surrounds a cover 44 closing the cylinder 40 and forming the severable wall portion W2. For tearing off the cover 44, the latter is connected to a handle 45. The connection is provided at a protrusion 46 from which the annular handle 45 extends in parallel to cover 44. Here, handle 45 is arranged in the horizontal transverse plane (transversely to axis A) of the packaging container.

Also in this embodiment, the whole packaging container, except for the barrier layer 24, is produced as a one-pieced plastic component.

The barrier layer 24 consists of a plane disk 47 which is arranged on the inner side below wall portion W1 and below cap 44 and covers the predetermined weakening zone 20. Barrier layer 24 is intimately connected to the material of fixed wall portion W1 and severable wall portion W2.

The third embodiment, depicted in FIGS. 7 and 8, largely resembles the second embodiment, however with the difference that the barrier layer 24 is connected to the outer side of fixed wall portion W1. Further, the severable wall portion W2 has been produced separately from the cartridge.

Specifically, according to FIG. 7, there is provided an elongate cylinder 40 having one open end and being closed on its other end by an end wall 41 forming the fixed wall portion W1. End wall 41 is provided with an opening 50 covered by cover 44, the latter having an edge 51 overlapping the end wall 41. Cover 44 includes a continuously surrounding predetermined weakening zone 20 enclosing the tear-off wall portion W2. Cover 44 is connected to a handle 45 extending from an upright protrusion 46 of the cover and arranged in parallel to cover 44.

Barrier layer 24 is located on the underside or inner side of cover 44. The layer extends up to a region below said edge 51 and in this region is connected to the outer side of fixed wall portion W1.

The packaging container according to this embodiment consists of a container portion and a separately produced cover portion, the edge 51 of the cover portion being connected, e.g. by welding, to the end wall 41 of the container portion. Barrier layer 24 covers the opening 50 of the container portions and extends beyond this opening, resulting in a high barrier effect in the region of opening 50 where also the predetermined weakening zone 20 is arranged.

In any case, the barrier layer 24 will increase the barrier effect of the predetermined weakening zone, thereby impeding a leakage of substances through the predetermined weakening zone 20.

The minimum wall thickness of the packaging container is 0.5 mm, preferably 1.2 mm and most preferably 2.8 mm. It is preferred that the fixed wall portion and the severable wall portion are rigid. The minimum wall thickness of the barrier layer is 0.05 mm, preferably 0.1 mm and most preferably up to 0.5 mm.

A further embodiment (not illustrated) resides in that a cap or a (screw) closure is connected to the container in such a manner that the barrier layer connects the cap/closure to the container and the barrier layer will be destroyed when the closure is unscrewed or the cap is removed.

Further, it is possible to apply a permeation-preventing barrier layer also partially under a region of the predetermined weakening zone, e.g. only at the site where the tear-off action shall be initiated. The purpose of such an arrangement resides in generating a predetermined weakening zone having a specified permeation thickness and resultant tear-open force.

Preferred suitable materials for the barrier layer are EVOH or HDPE as well as composite films which include a metal layer or at least one barrier layer made of EVOH, HDPE, PA or PP.

1. A packaging container of plastic, comprising a one-pieced container body (11) having a side wall and end wall (14,41), wherein, in the region of said end wall, a fixed wall portion (W1) and a severable wall portion (W2) are provided which are connected to each other by a predetermined weakening zone (20),
characterized in
that said predetermined weakening zone (20) is bridged by a barrier layer (24) effective to reduce permeation, said barrier layer (24) being connected to the fixed wall portion (W1) and the severable wall portion (W2).

2. The packaging container according to claim 1, characterized in that the severable wall portion (W2) is produced in one piece with the container body (11).

3. The packaging container according to claim 1, characterized in that the severable wall portion (W2) is provided with outer or inner injection-assistance webs (32).

4. The packaging container according to claim 1, characterized in that, in the region of the predetermined weakening zone (20), injection-assistance webs are provided between the fixed and the severable wall portions.

5. The packaging container according to claim 1, characterized in that the packaging container is a one-pieced cartridge (10) for containing substances adapted to be pressed out, comprising a container body (11) and a neck (15) forming the fixed wall portion, said neck (15) being closed by a cap (17) forming the severable wall portion (W2).

6. The packaging container according to claim 5, characterized in that the barrier layer (24) consists of a hood (27) covering the inner side of the neck (15) and of the cap (17).

7. The packaging container according to claim 1, characterized in that the fixed wall portion (W1) is formed by an end wall (41) of the packaging container and that the severable wall portion (W2) is a cover (44) surrounded by the predetermined weakening zone (20).

8. The packaging container according to claim 1, characterized in that the barrier layer (24) consists of a plane disk (47).

9. The packaging container according to claim 1, characterized in that the barrier layer (24) has an increased barrier effect relative to the plastic of the fixed wall portion.

10. The packaging container according to claim 1, characterized in that the barrier layer (24) consists of a composite film comprising a metallic layer and at least one plastic layer.

11. The packaging container according to claim 9, characterized in that the barrier layer covers also at least a part of said end wall (14,41) or of said side wall.

12. The packaging container according to claim 1, characterized in that the barrier layer (24) consists of a plastic layer injection-molded to the fixed wall portion (W1) and to the severable wall portion (W2).

13. The packaging container according to claim 12, characterized in that the predetermined weakening zone (20) is formed by a closed portion (16) between the fixed wall portion and the severable wall portion.

14. The packaging container according to claim 1, characterized in that, in the predetermined weakening zone (20), an opening is arranged which is filled by the barrier layer (24).

15. The packaging container according to claim 1, characterized in that the barrier layer (24) is connected to the inner side of the fixed wall portion (W1) and to the inner side of the severable wall portion (W2).

16. The packaging container according to claim 1, characterized in that the barrier layer (24) is connected to the outer side of the fixed wall portion (W1) and to the inner side of the severable wall portion (W2).

17. The packaging container according to claim 1, characterized in that the barrier layer (24) is connected to the inner side of the fixed wall portion (W1) and to the outer side of the severable wall portion (W2).

18. The packaging container according to claim 1, characterized in that a handle (18,46) is molded to the severable wall portion (W2).

19. The packaging container according to claim 5, characterized in that the container body (11) is cylindrical and has a longitudinal axis (A), and that the cap (17) is provided with a handle (18) arranged in a vertical longitudinal plane extending radially to said longitudinal axis.

20. The packaging container according to claim 1, characterized in that the severable wall portion is provided with a handle arranged within the contour (K) of the container body (11).

21. A method for producing a packaging container according to claim 1, characterized in that, prior to injection-molding the wall portions (W1,W2), a prefabricated barrier layer (24) is inserted into the injection mold.

22. A method for producing a packaging container according to claim 1, characterized in that the fixed wall portion (W1) and the severable wall portion (W2) are produced together by injection molding in one molding cycle and that the barrier layer (24) is applied during the same molding cycle or subsequent thereto.

23. A method according to claim 22, characterized by the use of a hollow mold provided with grooves for molding injection-assistance webs on the severable wall portion (W2) or in the region of the predetermined weakening zone (20).

24. A method according to claim 22, characterized by applying the barrier layer (24) to the inner side of the fixed wall portion (W1) and/or of the severable wall portion (W2).

25. A method according to claim 22, wherein the barrier layer (24) is connected by welding to the fixed wall portion and/or to the severable wall portion and the barrier layer (24) comprises at least one layer made of aluminum.

26. A method for producing a packaging container according to claim 1, characterized in that, at a time prior, during or subsequent to injection-molding the wall portions (W1,W2), a barrier-layer material (24) is injection-molded or formed to the inner sides of the wall portions.

27. A method for producing a packaging container according to claim 1, characterized in that the barrier layer (24) or the sever-able wall portion (W2) are connected to the fixed wall portion (W1) of the container by welding or bonding.

28. The method according to claim 21, characterized in that the barrier layer (24) is mounted in the form of a hood (27) onto a tool core provided to mold the inner side of a neck (15).

29. The method according to claim 21, characterized in that the barrier layer (24) is mechanically or pneumatically fixed against a molding tool.

30. The method according to claim 22, characterized in that the barrier layer (24) is connected in the form of a hood (27) to the inner side of a neck (15) or of a cap (17).

31. A packaging container of plastic, comprising a container body having a side wall (11a) and an end wall (14),
characterized in
that a predetermined weakening zone (20) is provided, connecting a severable wall portion (W2) to a fixed wall portion (W1) and being bridged by a barrier layer (24) effective to reduce permeation, the fixed wall portion being formed by a neck (15) closed by a cap (17) forming said severable wall portion.
